(19) United States
(12) Patent Application Publication
(10) Pub. No.: US 2026/0216681 A1
(43) Pub. Date: Jul. 30, 2026

(54) EASY-TO-HANDLE LIPOSOME EXTRUDER

(71) Applicant: Evonik Operations GmbH, Essen (DE)

(72) Inventors: Mario Gomez, Darmstadt (DE); Jürgen Erwin Lang, Karlsruhe (DE); Marcel Arndt, Moerfelden-Walldorf (DE)

(73) Assignee: Evonik Operations GmbH, Essen (DE)

(21) Appl. No.: 19/158,258

(22) PCT Filed: Feb. 15, 2024
(86) PCT No.: PCT/EP2024/053816

§ 371 Date: Aug. 20, 2025

(30) Foreign Application Priority Data
Feb. 23, 2023 (EP) 23158101.8

(51) Int. Cl. B01J 13/08

(52) U.S. Cl. CPC B01J 13/08

(57) ABSTRACT

An apparatus extrudes liposomes under elevated fluid pressures (P) through a filter element which is configured to be handled easily and quickly under clean room environments. Basic design principle of the apparatus is a pressure chamber approximating a lentile like shaped ellipsoid (E). The pressure chamber has two hemispheres, namely a fixed socket and a releasable cap. The pressure vessel is configured to be opened by lifting up the cup. The apparatus is equipped with an integrated guideway, which is designed to guide the cap vertically. The guideway keeps the alignment of the releasable cap to the fixed socket if the cap is released. As the guideway allows vertical translation of the cap only, tilting of the cap and offset is excluded. This effect is further supported by the oblate shape of the cap. This constellation helps removing and replacing the releasable cap in short time without complicated alignment.

Present invention relates to an apparatus for extruding liposomes and a process for producing liposomes by means of that apparatus.

Liposomes are essentially spherical structures having a diameter amounting from 25 nm to 1 μm. They comprise one or more concentric lipid bilayers that enclose an aqueous interior, the so-called lipid vesicle. Liposomes are produced by dispersing lipids in aqueous solution. Suitable lipids are in particular phosphatidylcholines (lecithins), phosphatidylethanolamines or phosphatidylserine (cephalins) Liposomes are used as carriers for pharmaceutical, cosmetic or nutraceutical active substances that are selectively enriched in certain organs and cell groups.

An overview of processes to prepare liposomes is given by Guo et al:
Guo, P., Huang, J., Zhao, Y., Martin, C. R., Zare, R. N., Moses, M. A.: Nanomaterial Preparation by Extrusion through Nanoporous Membranes. Small 2018, 14, 1703493. DOI: 10.1002/smll.201703493

One crucial characteristic of liposomes is their size distribution. In particular, liposomes for use in pharmaceutical, cosmetic or nutraceutical applications need to have a size distribution within a dense range. This means, that actual size of an individual liposome shall not deviate significantly from a specificized average. For that reason, defining a proper size is an important step during preparation of liposomes.

A common approach for sizing liposomes is extrusion. According to this, a feed dispersion comprising liposome precursors dispersed in a liquid dispersion medium is prepared first. This feed dispersion is subjected to a fluid pressure. The pressurized feed dispersion is then extruded through a porous filter element having a defined pore size. During extrusion, the size of the precursor liposomes is reduced. Beside pore size, energy input is a crucial parameter during extrusion. Liposomes are fluidic systems. They can pass e.g. a 100 nm membrane and form particles with average size of 250 nm afterwards. Thus, for an effective reduction of diameter, liposomes need more passes than one pass through the extruder in general. Such liposome extrusion process is commonly understood as a pure physical operation without chemical interaction. Thus, the chemical composition of target liposomes is already given by liposome precursors.

In commercial liposome extrusion processes, dense polycarbonate plates are used as filter elements. The porosity of these items usually amounts from 100 nm to 5 μm.

The size of precursor liposomes is typically in the range from 50 nm to 10 μm. To effect extrusion of precursor liposomes through dense filter elements, elevated pressures are necessary. Mid pressure processes are working with fluid pressures ranging from 20*10⁵ Pa to 40*10⁵ Pa (20 to 40 bar), while high pressure processes achieving nominal fluid pressures amounting from 100*10⁵ Pa to 200*10⁵ Pa (100 to 200 bar).

An apparatus for performing such liposome extruding process is called liposome extruder. Essential compounds of a liposome extruder are a vessel to which the liquid dispersion of the precursor is fed to, means for applying a fluid pressure on that precursor contained in the vessel and the porous filter element, through which the precursor is extruded out of the vessel.

For bearing elevated pressures, mechanical design of liposome extruders must be tough enough. For security reasons, extruder design must be able to contain an inner pressure even higher than extrusion pressure. Due to common rules on pressure vessels, the extruder must be designed to stand inner pressures higher by a factor between 1.3 and 1.7 than the nominal operational pressure. Thus, liposome extruders need to be designed very heavy to keep such high pressures.

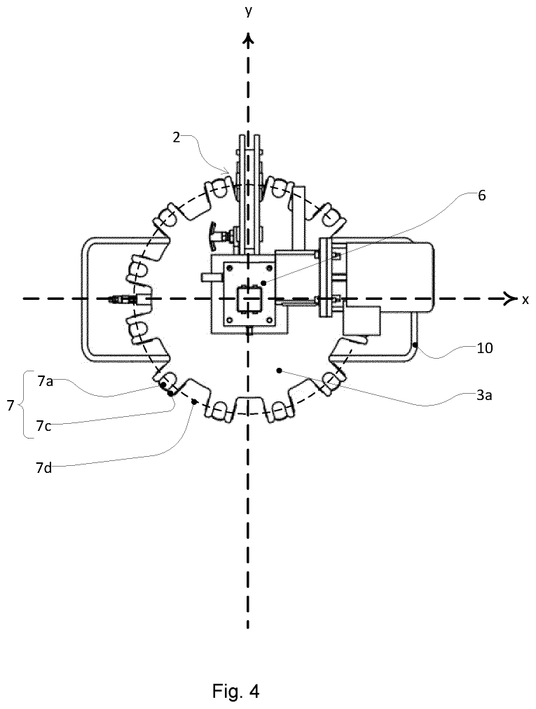

Examples of liposome extruders are known from WO 2021/207841 A1 or from FIG. 4 and related description of WO 01/05373 A1. Both items described in the respective document are equipped with a pressure chamber composed of two hemispheres, namely a fixed socket and a cap which is releasably coupled with the socket. The pressure chamber has a one-way inlet defined by a backpressure-valve and an outlet which is defined by a filter element. The precursor feed is introduced through the inlet into the pressure chamber. In the pressure chamber, the feed is subjected to fluid pressure. The latter drives precursor mixture through the filter element out of the pressure chamber to facilitate extrusion.

In daily operation, liposome sizing processes utilizing such extrusion apparatuses run until filter element loses penetrability due to clogging. Then, apparatus is depressurized, cap and socket are released from each other, cap is removed, filter element with reduced penetrability is replaced by a fresh filter, cap and socket are recoupled with each other, apparatus is repressurized and liposome extrusion is continued.

When liposomes are produced for pharmaceutical, cosmetic or nutraceutical applications, strict requirements regarding hygienic conditions need to be fulfilled. Thus, liposome extruders are installed in clean rooms which are entered only by staff wearing protective clothing. For pharmaceutical application when handling high potent drugs (like e.g. the anti-cancer drug doxorubicin) it is also necessary to conduct the extrusion under secondary containment to avoid contamination of production personal. Due to the hygienic requirements, handling of heavy extruder parts is ambitious: For instance, the weight of the cap of a typical high-pressure chamber amounts up to 50 kg. Therefore, a crane for manipulation is needed. Operating the crane and replacing the filter element while wearing high level protective clothing and/or under secondary containment is very exhausting for the staff. In particular, the precise alignment of cap to socket to enable secure sealing is very ambitious. Exchanging the filter element of conventional liposome extruders under enhanced hygienic requirements takes therefore a long time of 20 up to 30 minutes, even if two operators are engaged. Unplanned and prolonged setup-time can be a source of violations of good manufacturing practice (GMP deviations).

In light of this, it is an object of present invention to provide an apparatus for extruding liposomes under elevated fluid pressures trough a filter element which can be handled easily and quickly under clean room environments. In particular, replacement of a worn filter element shall be possible in short time.

This object is solved by an apparatus for extruding liposomes, comprising the following components:
means for applying a fluid pressure P on a liquid medium, wherein said fluid pressure P amounting from 20*10⁵ Pa to 200*10⁵ Pa;
a frame comprising a vertical guideway;
a pressure chamber comprising a socket and a cap releasably coupled with each other, wherein said socket is fixed to said frame, wherein said cap is vertically guided by said vertical guideway, wherein said pressure chamber is designed for bearing an inner fluid pressure P_{b} calculated by P_{b}=S*P, with S being a reasonable security factor, S preferably selected from the range extending from 1.3 to 1.7 and wherein said cap comprises an inner surface approximating an ellipsoid defined by equitation:

$${x}^{2} / {a}^{2} + {y}^{2} / {b}^{2} + {z}^{2} / {c}^{2} = 1$$

wherein x, y and z are Cartesian coordinates with x and y are orientated horizontally and z is orientated vertically, wherein a, b and c are defined as lengths of semiaxes of said ellipsoid and wherein said pressure chamber is designed that lengths a, b, c of semiaxes of ellipsoid fulfilling both conditions: c<a and c<b; wherein said cap (x) is designed that lengths a and b of semiaxes of ellipsoid (E) fulfilling condition a=b<500 mm or a=b<300 mm;
a filter holder, which is removably mounted in the socket;
at least one porous filter element defining an outlet of said pressure chamber, wherein said filter element comprises open pores having a diameter D, wherein said pore diameter D amounting from 50*10⁻⁹ m to 50*10⁻⁶ m or from 80*10⁻⁹ m to 5*10⁻⁶ m, whereby the filter element is contained in said filter holder.

The inner surface of the cap approximating an ellipsoid defined by equitation as stated shall mean a partial area of the total inner surface of the cap. According one beneficial version of the apparatus, the (partial) inner surface according to the stated equation covers a minimum of 60% of the total inner surface of the cap, preferred a minimum of 70% of the total inner surface and most beneficial a minimum of 80% of the total inner surface.

This apparatus is a first subject matter of present invention.

Basic design principle of present apparatus is a pressure chamber having a cap approximating an ellipsoid shape with an inner surface, whereby the vertical diameter of the ellipsoid is smaller than the horizontal diameters. Thus, the ellipsoid is oblate, similar like a lentil. The cap is part of the pressure chamber that is composed of two hemispheres, namely a fixed socket and said cap (releasable). The pressure vessel can be opened by lifting up the cap. The extruder is equipped with an integrated guideway, which is designed to guide the cap vertically. The idea of this guideway is to keep the horizontal alignment of cap to the socket if cap is released. In addition to that, the axial position of the cap relatively to the socket is kept. Both helps to rematch both hemispheres when mounting cap to socket: As the guideway allows vertical translation of the cap only, tilting of the cap and offset is excluded. This effect is further supported by the oblate shape of the cap: As the moment of tilt out of the horizontal plane is higher due to enlarged horizontal diameters, the cap is better stabilized in horizontal plane than an ideal sphere having an identical diameter in all directions. This constellation helps removing and replacing the cap in short time without complicated alignment.

A further beneficial feature of present apparatus is a filter holder in which the porous filter element is contained. The filter element is intended to be used only for a limited time of operation. Its lifetime is ruled by its permeability, the latter decreases due to clogging over time. The filter holder is intended to be used permanently. As it is removably mounted to the socket, it can be picked up quickly once the pressure vessel has been opened by lifting up the cap. Since the filter holder does not bear the pressure, it can be designed light weight. Due to its low weight, a single operator is able to remove the filter holder with ease by hand. Replacement of the actual filter element can be accomplished at a place situated distantly to the location of the fixed socket. In particular, it is possible to carry the filter holder away to a distant place with better ergonomic conditions. The worn filter element is replaced there by a fresh one and the filter holder is laid back into the socket.

In a nutshell, compared with conventional equipment, design of present liposome extruder allows a quicker replacement of the filter element at less efforts for the personnel even in a clean room environment.

According to the inventive concept of an oblate ellipsoid shaped cap of pressure chamber, the vertical semiaxis c of the ellipsoid is shorter than the horizontal semiaxis a and b. However, the horizontal semiaxis a and b do not necessarily be identical. Hence, within the horizontal plane the pressure chamber may have an elliptic circumference. But to optimize the ability to be tightened, it is desirable to have an ideal circular circumference in horizontal plane. Thus, according to a preferred embodiment, cap of pressure chamber is designed that lengths a and b of semiaxes of ellipsoid fulfilling condition a=b. Having identical horizontal semiaxis a, b, the circumference in the horizontal plane is circular. According to a preferred embodiment, the dimensions for a and b are below 500 mm or even below 300 mm, and the lower limit for a and b may be 100 mm. The vertical dimension c (length of z-semiaxis) may be between 10 mm and 20 mm.

In favour of a good handiness the weight of at least the cap should be minimized. Thus, material needs to be reduced. Low amount of material results in high mechanical stress under inner pressure. For guaranteeing safety, shape of pressure chamber needs to be designed stress optimized. The latter can be achieved by using a convex ellipsoid. Convex means that an imagined segment between two points on the ellipsoid surface of the pressure chamber extends inside the pressure chamber. A convex curved pressure chamber can be constructed with less weight than a concave curved one at identical pressure resistance.

According to a preferred embodiment of the apparatus, the filter holder is comprised of a substantially flat support screen and one or more filter elements, whereby flat support screen substantially extends horizontally. Such flat support screen can be fitted very comfortably onto the socket. It extends preferably within the horizontal junction plane between socket and cap. The support screen may be equipped with either a single filter element or an array of several parallelized filter elements.

The support screen itself may be porous and is configured such that a liquid medium can flow through the filter holder.

Optionally, filter holder additionally comprises at least one flat porous drain element, being situated between support screen and filter element. The pore size of said drain element shall be greater than pore size of filter element but still smaller than pore size of flat support screen. Such drain element prevents extrusion of the filter element into the pores of the support screen.

Preferably, filter holder includes at least two handles to be grabbed for removing filter holder from the socket. In particular, if the filter holder is configured as a flat support screen such lightweight filter holder can be manipulated manually if equipped with such handles.

However, if extrusion pressure requires a heavier construction, the filter holder shall be made of a material having a higher magnetic permeability than the material of the socket. This allows picking the filter holder with a lifting magnet attached to a crane. If the magnetic permeability of the socket was the same than the filter holder, the magnetic lifter would stick to both parts. Thus, releasing of the filter holder was not possible. Preferably, the filter holder is made of a stainless steel while the socket is made of an anti-magnetic stainless steel. Examples for a suitable steel grades are: 1.4016, 1.3813, 1.3952, 1.3964, 1.3974.

The filter element may of an approved design, namely configured as a plain plate made of a porous material selected from the group consisting of polycarbonate, sintered metal, and metal foil. The plain plate is preferably of circular shape.

Shape of filter element is preferably flat and circular (disk shape). Typical disc diameter of filter element may be between 20 mm and 50 mm, for instance 25 mm. The pore diameter D of the filter element shall amount from 50*10⁻⁹ m to 50*10⁻⁶ m or from 80*10⁻⁹ m to 5*10⁻⁶ m. For instance, a pore diameter of 0.1 μm may be used. Pore size is given by vendor of filter element and may be verified by optical means, or by transmission electron microscopy (TEM) or by scanning electron microscope (SEM).

Inventive apparatus works with commercially available filter elements. For example, Whatman Nuclepore polycarbonate hydrophilic membranes may be used as filter element. The latter are obtainable from Cytiva Europe GmbH, Freiburg, Germany.

The guideway is designed to keep the correct alignment of the cap in relation to the socket. However, it is not capable to provide the force to lift the cap. The latter is applied manually by the operator or—if the cap is heavy—by an external crane. For speeding up handling of heavy cap, the apparatus is preferably featured by a lifting mechanism designed for elevating the cap. The lifting mechanism makes an external crane dispensable. It is desired if the weight of the cap is too high to be handled manually.

Preferably, the lifting mechanism is functionally separated from the guideway. This construction approach allows a precise guidance compared to an integrated design. Separated design means that the function of vertical guidance is achieved by different components than the lifting function.

According to a further improved embodiment the frame of the apparatus comprises one, preferably exactly one vertically erected beam extending outside of said pressure chamber, wherein said beam forms a guide rail, and wherein said cap is equipped with a rider, which is vertically movable on said rail so as the said guideway is composed of guide rail and rider. Such single beam construction allows an easy access to the opened pressure chamber for removing the filter holder over a broad sector compared to a multi beam design.

Preferably socket and cap are releasably coupled with each other by a screw connection, wherein said screw connection comprises a plurality of vertically extending bolts which are situated on a horizontally arranged bolt circle, whereby effective axis of vertical guideway points on periphery of said bolt circle. Such design has been identified to be stable and friendly to access.

If using a bolt connection, at least one bolt may be pivotally mounted to said socket, wherein rotational axis between said bolt and said socket is extending horizontally. The cap is equipped with a hooked receptacle, for a nut threaded to the bolt. In particular a high-pressure chamber requires heavy screws which need to be manipulated as well. If the bolts are pivoted horizontally, operator needs not to introduce heavy bolts into threaded holes (very time consuming). In this embodiment, the bolts are simply pivoted such that nut is receipt by corresponding hook of the cap. The number of rotations to fix this bolt connection is less than screwing the bolt vertically in a threaded hole. This makes the handing quicker. Beyond that, the bolts cannot get lost. Preferably all bolts are pivoted horizontally in that way.

Thanks to its robust construction, inventive apparatus may be operated a broad pressure range from 20*10⁵ Pa to 200*10⁵ Pa. This covers mid pressure processes working with fluid pressures ranging from 20*10⁵ Pa to 40*10⁵ Pa (20 to 40 bar) and high pressure processes achieving nominal fluid pressures amounting from 100*10⁵ Pa to 200*10⁵ Pa (100 to 200 bar) as well. Intermediate pressures, for instance between 60*10⁵ Pa and 70*10⁵ Pa, are operable also.

Yet another subject matter of the present invention is a process for preparing target liposomes from liposome precursors employing inventive apparatus. This method comprises the following steps:
a) providing the inventive apparatus;
b) providing a feed dispersion comprising liposome precursors dispersed in a liquid dispersion medium;
c) applying a hydraulic pressure P amounting from 20*10⁵ Pa to 200*10⁵ Pa on said feed dispersion to obtain a pressurized feed dispersion;
d) extruding said pressurized feed dispersion through filter element of apparatus to obtain an extruded dispersion comprising target liposomes dispersed in dispersion medium;
e) optional: recovery of target liposomes from extruded dispersion.

Inventive production method is conducted similar to a conventional liposome extrusion process. Conventional equipment needs to be replaced by the inventive liposome extruder only. Thus, implementation of the new process can be accomplished quickly. As extrusion pressures and filter element are conventional ones, identical product quality is to be expected. Thus, during normal operation, inventive liposome extrusion process achieves the same results as a conventional one.

The benefit over conventional preparation method is achieved when the process is performed until reaching a defined clogging degree of said filter element. This is a normal phenomenon due to clogging of the filter element. Thanks to the inventive design of employed apparatus, the worn filter element can be replaced quick and easily be the following steps: After reaching defined clogging degree apparatus is depressurized, cap and socket are released from each other, cap is elevated, filter holder containing filter element with reduced penetrability is replaced by a fresh filter holder containing a fresh filter element, cap is lowered, socket and cap are recoupled with each other, apparatus is repressurized and process is continued.

The particular benefit is that the cap needs not to be aligned in a complicated manner to the socket before recoupling, as the horizontal and axial position of the cap to the socket is maintained by the guideway. Further, the filter element is removed together with the filter holder. The filter holder may be transported to a place with optimized ergonomic conditions for removing the filter element from the filter holder to build in a fresh one. In particular, this is beneficial if the filter holder contains many single filter elements that need to be replaced. Beyond that, it is possible to prepare the fresh filter holder with fresh filter element during operation of the apparatus. When the running process is stopped, just the filter holder carrying the worn filter elements is replaced by the fresh one. This is even faster than replacing filter elements in the filter holder during shut down. However, this requires at least two filter holders, a first one in operation and a second one under preparation for replacing the first one. Thus, a “fresh filter holder” in the sense of the invention may either be the same item as the filter holder that was carrying the worn filter elements before or a second item currently not in operation.

Thanks to the superior handling of present apparatus, the replacement of the filter elements can be accomplished in short time. In particular, the steps of depressurizing apparatus, releasing cap and socket from each other, elevation of cap, replacement of filter holder containing filter element with reduced penetrability by a fresh filter holder containing a fresh filter element, lowering the cap, recoupling socket with cap, repressurizing apparatus may be performed within 5 minutes or less.

If the filter holder is made of a material having a higher magnetic permeability than the material of the socket, the filter holder may be removed from the socket by means of a magnetic manipulator. The latter may be a magnetic lifter attached to a crane. This makes it easy to remove heavy versions of the filter holder that cannot be carried by hand. It is worth to mention that the filter holder is in any case lighter than the cap of the pressure chamber, as the filter holder is placed inside chamber and does therefore not need to carry the full inner pressure as the cap and socket do. The pressure force is concentrated on region of the filter element only. Thus, the filter element can be dimensioned lighter.

Present invention shall be illustrated more in detail by means of figures showing an exemplary embodiment. In particular, it shows

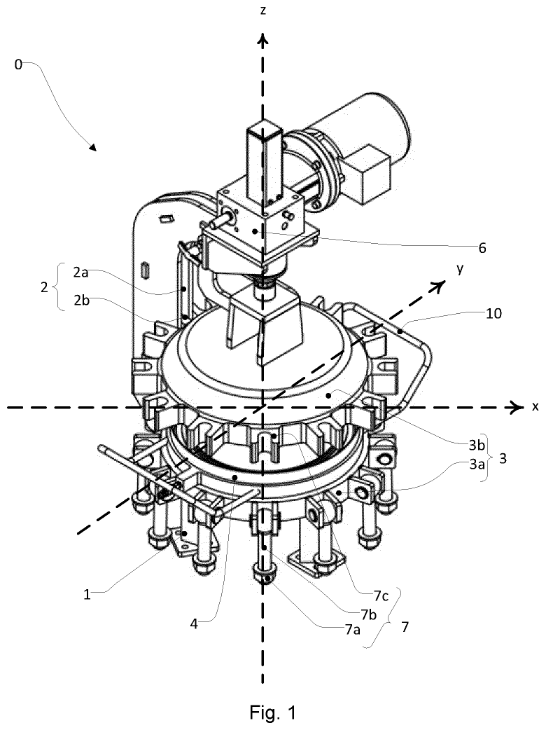

FIG. 1: Apparatus, cap lifted, perspective view,

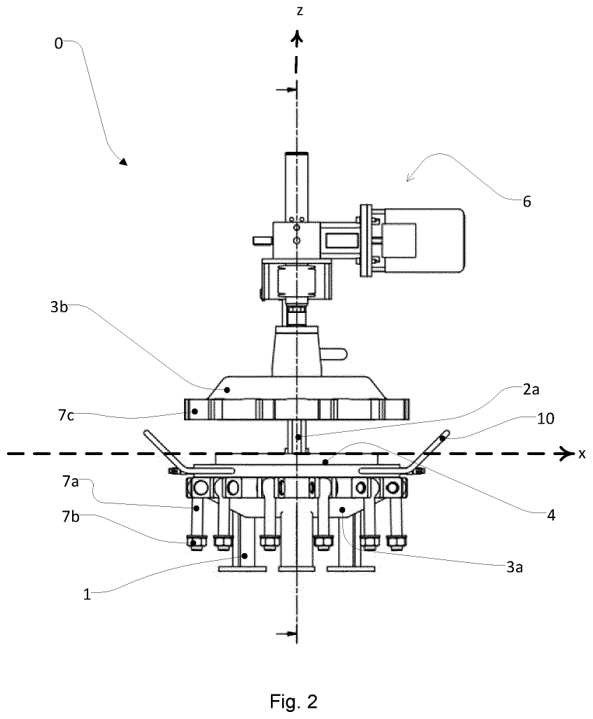

FIG. 2: Apparatus, cap lifted, side view;

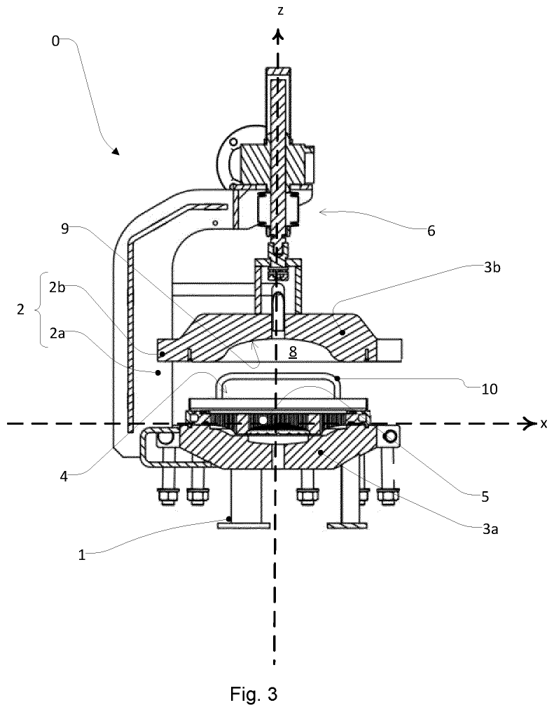

FIG. 3: Apparatus, cap lifted, sectional view from FIG. 2;

FIG. 4: Apparatus, elevated view from top;

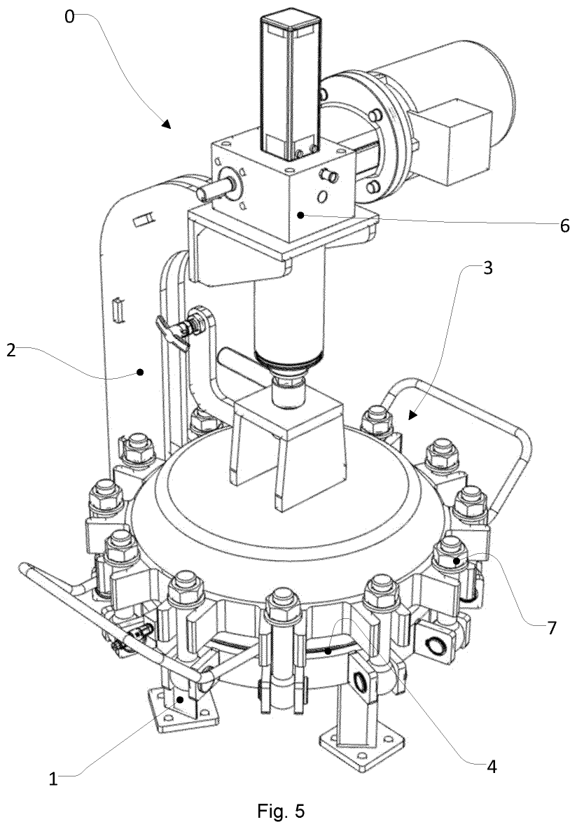

FIG. 5: Apparatus, cap coupled to socket, perspective view,

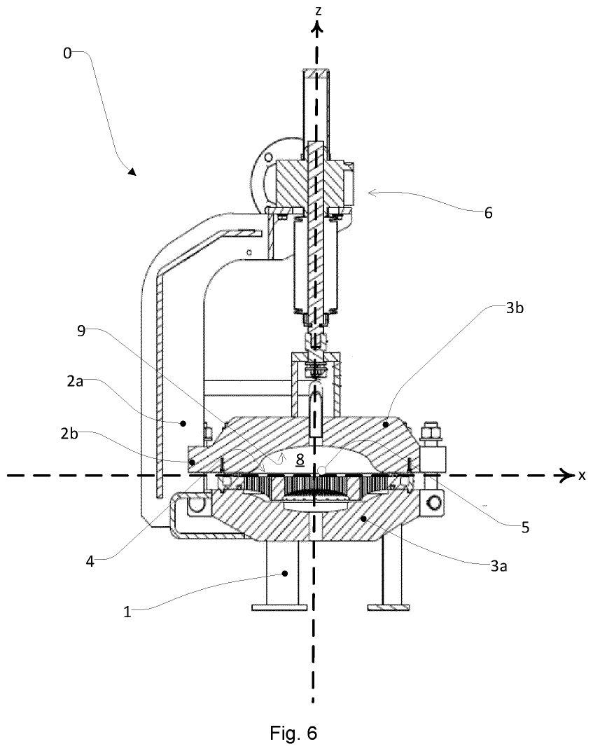

FIG. 6: Apparatus, cap coupled to socket, sectional view;

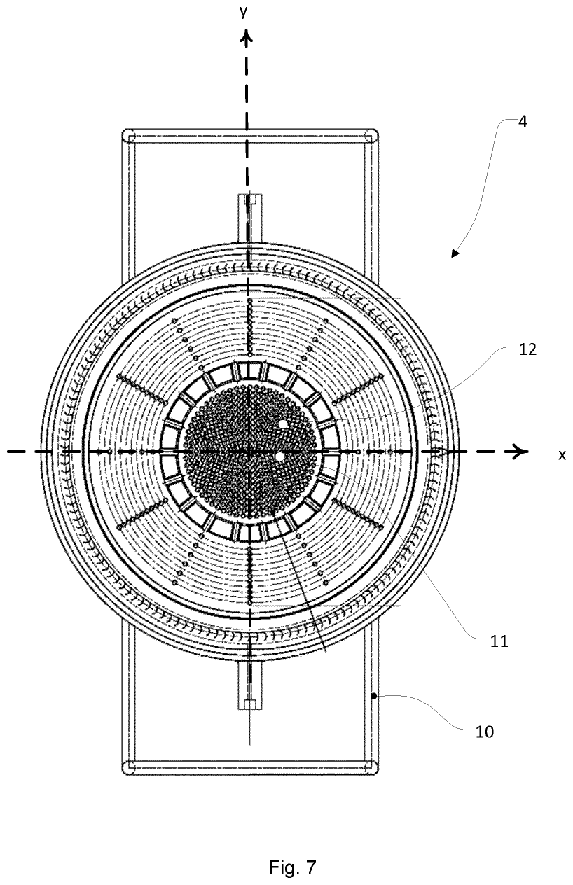

FIG. 7: Filter holder, elevated view from top;

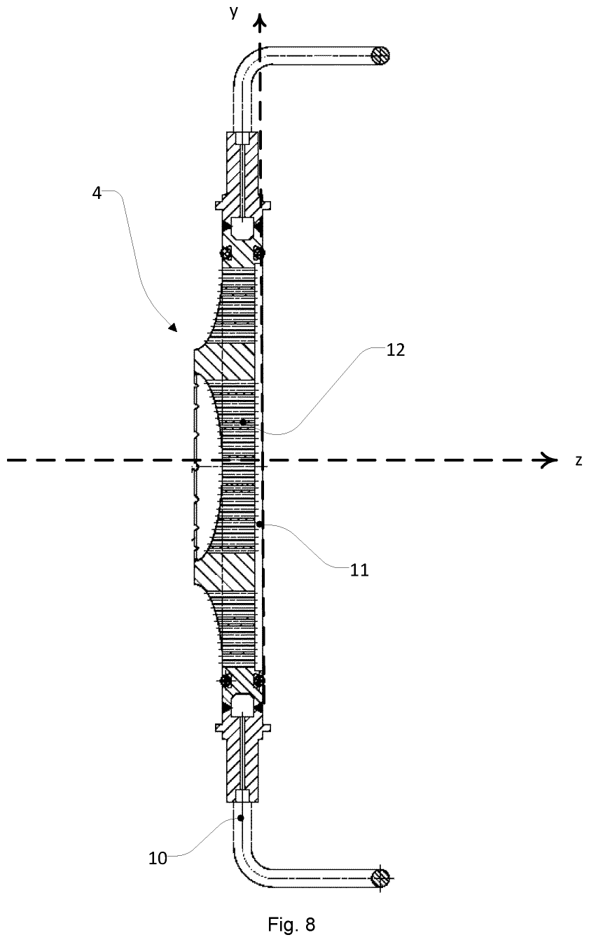

FIG. 8: Filter holder, sectional view;

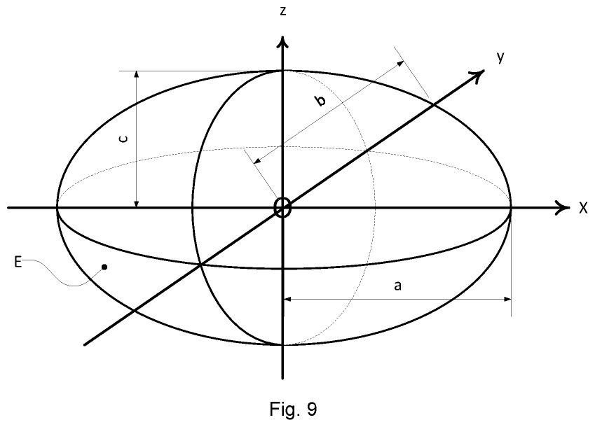

FIG. 9: Ellipsoid E, perspective view.

For general orientation, in some Figures directions of Cartesian coordinates x, y and z are indicated. As usual, x and y are orientated horizontally, while z axis is parallel to direction of gravity, hence vertically.

Perspective view of an embodiment of inventive apparatus 0, a so-called liposome extruder, is shown in FIG. 1. Apparatus 0 comprises a stationary frame 1 which is provided with a vertical guideway 2. The guideway 2 is composed of a guide rail 2a that is fixed to a beam of the frame 1 and a movable rider 2b. The rider 2b is movable in vertical direction only, i.e., in direction of z-axis. The guide rail 2b constitutes the non-moving part of the vertical guideway 2. Rider 2b and rail 2a may be designed as a dovetail (not shown).

Central part of apparatus is a pressure chamber 3 that is composed of a socket 3a and a cap 3b. The socket 3a is fixed to the frame 1, while the cap 3b is fixed to the rider 2b of the vertical guideway 2 and therefore movable in vertical (z) direction only. Movement in z-direction is translation only. All further movements of the cap 3b (translation in direction of x or y axis or pivoting around x, y or z axis) are restricted by the vertical guideway 2.

The socket 2a is provided with a receptacle for a filter holder 4. Filter holder 4 is configured as a substantially flat screen containing a plurality of inserted filter elements 5. The latter are visible in FIG. 7 best. Each filter element 5 is configured as a flat plate made of porous polycarbonate.

Further parts of apparatus 0 are means for applying a fluid pressure (not shown) and a lifting mechanism 6 for lifting the cap 2b. The lifting mechanism 6 is functionally separated from the vertical guideway 2. This means that the lifting mechanism 6 applies the force to lift and hold the cap 2b, while the guideway rules the direction of movement only. Lifting mechanism 6 may be a worm gear with motor or a hydraulic piston.

During operation (FIGS. 5, 6, 7) the filter holder 4 with filter elements 5 contained therein is placed into the socket 3a. The cap 3b is placed on the socket 3a and both parts 3a, 3b are fixed to each other by means of a bolt connection 7. The inlet into the pressure chamber 3 is established by the means for applying the pressure (not shown), while the outlet out of the pressure chamber is defined by the filter elements 5.

As shown in FIG. 6, the pressure chamber 3 composed by socket 3a and mounted cap 3b defines an inner cavity 8 having an ellipsoid shape. In particular, an inner surface 9 of the cap 3b approximates an ellipsoid E which is defined by the following equitation:

$${x}^{2} / {a}^{2} + {y}^{2} / {b}^{2} + {z}^{2} / {c}^{2} = 1$$

In this equitation, x, y and z are the Cartesian coordinates and a, b and c are defined as lengths of semiaxes of the ellipsoid. The ellipsoid E and its dimensions are shown in FIG. 9. The inner surface 9 of cap 3b defining the edge of the inner cavity 8 is configured that lengths a, b, c of semiaxes of ellipsoid fulfilling both conditions: c<a=b. This means that ellipsoid E is circular in vertical view but oblate in any horizontal view.

For extruding liposomes, a feed dispersion containing liposome precursors are fed into the cavity of the closed pressure chamber and subjected to a fluid pressure P. The fluid pressure P may be applied either hydraulically or pneumatically. High pressure appliance ranges from 100*10⁵ Pa to 200*10⁵ Pa, while mid pressure appliance is between 20*10⁵ Pa to 40*10⁵ Pa.

Pressure chamber 3, in particular socket 3a, cap 3b and bolt connection 7 are dimensioned to load the forces resulting from an even higher inner pressure P_{b}. For security reasons, pressure chamber can stand an inner pressure P_{b} amounting to 1.6 times of the actual operating pressure P. 1.6 is an example for a security factor S. The latter may be lower or higher, depending on local requirements. Typical security factors for pressure vessels ranging from 1.3 to 1.7. The skilled person is able to select an appropriate security factor.

Fluid pressure P forces the dispersion containing the liposome precursors through the filter element 5 out of the pressure chamber 3. As the filter element 5 is equipped with a defined porosity, the size of the liposomes is reduced to the size of the pores after a certain numbers of passes through. Thus, by selecting a filter element 5 with a given porosity, the pressure and the number of passes, the size distribution of the liposomes exiting the filter element 5 are ruled.

The extruded dispersion containing the target liposomes of desired size is withdrawn from the apparatus 0. It may be used either directly as intended dosage form of liposomes or may be subjected to further production steps. For instance, residual organic solvents are to be removed or liposomes may be loaded with active ingredients downstream of the liposome extruder. The liposomes may be separated from the dispersion if needed.

Due to clogging, the pores of the filter element 5 will be blocked after a certain operation time of the liposome extrusion process. As a result, the flow through the filter is going down and will stop at some point. To re-establish dense size distribution, worn filter element 5 must be replaced by a fresh one.

For this purpose, fluid pressure P is released and pressure chamber 3 is opened by detaching the cap 3b from the socket 3a and lifting the cap 3b.

Detaching is accomplished by opening the bolt connection 7. Bolt connections consists of a plurality of bolts 7a, each screwed into a respective nut 7b clamped into a u-shaped hook 7c at the cap 3b. Opening of bolt connection 7 is quite simple as each bolt 7a is attached pivotally around a horizontal axis directed tangentially to the circumference of the socket 3a. After untightening the nut 7b, the bolt 7a with nut 7b can be pivoted around horizontal axis to release the hook 7c. The bolts 7a will not get lost as they are attached to the socket. Further, the bolts 7a need not to be lifted, pivoting is lighter. Finally, the number of revolutions to tighten or untighten the screw connection is reduced as the nut 7b needs not to be removed from the bolt. Removing a complete bolt out of a thread needs more revolutions. At a glance, bolt connection 7 of present apparatus can be opened or closed quickly.

Once if the bolt connection 7 is opened, cap 3b can be lifted by means of the lifting mechanism 6. When cap 3b lifted, filter holder 4 can be removed from socket 3a by grabbing handles 10. If only one filter holder 4 is available, fresh filter elements 5 can be inserted into the filter holder by replacing the worn ones. The faster way is to provide two filter holders: The fresh one can be prepared during extrusion. This reduces the shut down time of the process.

It can be seen best in elevated view in z direction displayed in FIG. 4 that bolts 7a are situated on a bolt circle 7d. The axis of the vertical guideway 2 is situated inside the bolt circle 7b. This allows easy access to all bolts from all sides and a broader sector for removing the filter holder 5 from the socket.

FIGS. 5 and 6 are similar to FIGS. 1 and 3, however with cap 3b closed.

FIG. 7 shows filter holder 4 separately in elevated view (x/y-plane). Filter element (not shown) is to be placed in a central receptacle 11 having a porous flat support screen 12. As filter holder 4 is situated inside of pressure chamber, is does not need to bear high pressure loads. Thus, it is designed light-weight. For easy moving by hand, filter holder 4 is equipped with two handles 10. Filter holder 4 is intended for continuous use, while filter element is replaced when worn.

From sectional view of filter holder 4 in FIG. 8, receptacle 11 for filter element and porous flat support screen 12 are derivable by ease.

Not shown here is a flat porous drain element to be placed between support screen 12 and filter element 5. Porosity of drain element is chosen in a manner that pore diameter of drain element is larger than of filter element 5 but smaller than of support screen 12. Such drain element prevents extrusion of filter element 5 into pores of support screen 12.

### REFERENCES

x first horizontal axis
y second horizontal axis
z vertical axis
0 Apparatus/liposome extruder
1 Frame
2 guideway
2a guide rail
2b rider
3 pressure chamber
3a socket
3b cap
4 filter holder
5 filter element
6 lifting mechanism
7 bolt connection
7a bolt
7b nut
7c hook
7d bolt circle
8 cavity
9 inner surface
10 handles
11 receptacle
12 porous flat support screen
E ellipsoid
a length of semiaxis of ellipsoid in x direction
b length of semiaxis of ellipsoid in y direction
C length of semiaxis of ellipsoid in z direction
P fluid pressure
P_{b} inner pressure
S security factor
D diameter of pores in filter element

1. An apparatus for extruding liposomes, the apparatus comprising:
a pressurization unit for applying a fluid pressure P on a liquid medium, wherein said fluid pressure P amounts from 20*10⁵ Pa to 200*10⁵ Pa;
a frame comprising a vertical guideway;
a pressure chamber comprising a socket and a cap releasably coupled with each other, wherein said socket is fixed to said frame, wherein said cap is vertically guided by said vertical guideway, wherein said pressure chamber is designed for bearing an inner fluid pressure P_{b} calculated by P_{b}=S*P, with S being a reasonable security factor and wherein said cap comprises an inner surface approximating an ellipsoid (E) defined by equitation:
$${x}^{2} / {a}^{2} + {y}^{2} / {b}^{2} + {z}^{2} / {c}^{2} = 1$$
wherein x, y and z are Cartesian coordinates with x and y are orientated horizontally and z is orientated vertically, wherein a, b and c are defined as lengths of semiaxes of said ellipsoid (E) and wherein said pressure chamber is designed that lengths a, b, c of semiaxes of ellipsoid (E) are fulfilling both conditions: c<a and c<b; wherein said cap (x) is designed that lengths a and b of semiaxes of ellipsoid (E) are fulfilling condition
$$a = b < 500 mm or a = b < 300 mm ;$$
a filter holder, which is removably mounted in the socket;
at least one porous filter element defining an outlet of said pressure chamber, wherein said at least one porous filter element comprises open pores having a diameter D, wherein said pore diameter D amounts from 50*10⁻⁹ m to 50*10⁻⁶ m or from 80*10⁻⁹ m to 5*10⁻⁶ m, whereby the at least one porous filter element is contained in said filter holder.

2. The apparatus according to claim 1, wherein said cap is designed that lengths a and b of semiaxes of ellipsoid (E) are fulfilling condition a=b.

3. The apparatus according to claim 1, wherein the ellipsoid (E) is convex.

4. The apparatus according to claim 1, wherein said cap is designed that length c of semiaxis of ellipsoid (E) is fulfilling condition 10<c<20 mm.

5. The apparatus according to claim 1, wherein said filter holder comprises a substantially flat support screen and at least one porous filter element, whereby the substantially flat support screen substantially extends horizontally and wherein the substantially flat support screen is porous and is configured such that a liquid medium is configured to flow through the filter holder.

6. The apparatus according to claim 5, wherein the filter holder additionally comprises at least one flat porous drain element, being situated between the substantially flat support screen and the at least one porous filter element, wherein a pore size of the at least one porous drain element is greater than a pore size of the at least one porous filter element and wherein the pore size of the at least one porous drain element is smaller than the pore size of the substantially flat support screen.

7. The apparatus according to claim 1, wherein said filter holder includes at least two handles to be grabbed for removing said filter holder from the socket.

8. The apparatus according to claim 1, wherein said filter holder is made of a material having a higher magnetic permeability than a material of the socket.

9. The apparatus according to claim 1, wherein said at least one porous filter element is a plain plate made of a porous material selected from the group consisting of polycarbonate, sintered metal, and metal foil.

10. The apparatus according to claim 1, further comprising:
a lifting mechanism designed for elevating the cap.

11. The apparatus according to claim 10, wherein said lifting mechanism is functionally separated from said vertical guideway.

12. The apparatus according to claim 11, wherein said frame comprises one vertically erected beam extending outside of said pressure chamber, wherein said vertically erected beam forms a guide rail, and wherein said cap is equipped with a rider, which is vertically movable on said guide rail so as the said vertical guideway is composed of said guide rail and said rider.

13. The apparatus according to claim 12, wherein said socket and said cap are releasably coupled with each other by a bolt connection, wherein said bolt connection comprises a plurality of vertically extending bolts which are situated on a horizontally arranged bolt circle, wherein an effective axis of said vertical guideway points on a periphery of said horizontally arranged bolt circle.

14. The apparatus according to claim 13,
wherein at least one bolt is pivotally mounted to said socket,
wherein a rotational axis between said at least one bolt and said socket is extending horizontally.

15. A process for preparing target liposomes from liposome precursors, the process comprising:
a) providing an apparatus for extruding liposomes according to claim 1;
b) providing a feed dispersion comprising liposome precursors dispersed in a liquid dispersion medium;
c) applying a hydraulic pressure P amounting from 20*10⁵ to 200*10⁵ Pa on said feed dispersion to obtain a pressurized feed dispersion;
d) extruding said pressurized feed dispersion through the at least one porous filter element of the apparatus to obtain an extruded dispersion comprising target liposomes dispersed in the liquid dispersion medium;
e) optional: recovering recovery of target liposomes from the extruded dispersion.

16. The process according to claim 15, comprising:
performing the process until reaching a defined clogging degree of said at least one porous filter element, wherein after reaching the defined clogging degree the apparatus is depressurized, the cap and the socket are released from each other, the cap is elevated, the filter holder containing the at least one porous filter element with reduced penetrability is replaced by a fresh filter holder containing a fresh filter element, the cap is lowered, the socket and the cap are recoupled with each other, the apparatus is repressurized and the process is continued.

17. The process according to claim 16, wherein the following are performed within 5 minutes or less:
the apparatus is depressurized, the cap and the socket are released from each other, the cap is elevated, the filter holder containing the at least one porous filter element with reduced penetrability is replaced by a fresh filter holder containing a fresh filter element, the cap is lowered, the socket and the cap are recoupled with each other, and the apparatus is repressurized.

18. The process according to claim 17, wherein the filter holder is made of a material having a higher magnetic permeability than the material of the socket, wherein the filter holder is removed from the socket by a magnetic manipulator.
